(19) United States
(12) Patent Application Publication
(10) Pub. No.: US 2009/0315218 A1
(43) Pub. Date: Dec. 24, 2009

(54) INJECTION MOLD AND MOLDING METHOD FOR RESIN MOLDING

(75) Inventor: Norifumi Izumo, Hammatsu-shi (JP)

Correspondence Address: DARBY & DARBY P.C., P.O. BOX 770, Church Street Station, New York, NY, 10008-0770, US

(73) Assignee: Suzuki Motor Corporation, Hamamatsu-shi (JP)

(21) Appl. No.: 12/420,985

(22) Filed: Apr. 9, 2009

(30) Foreign Application Priority Data
Jun. 24, 2008 (JP) 2008-165013

(51) Int. Cl. B29C 45/18; B29C 45/03

(52) U.S. Cl. 264/328.12; 425/585; 425/577

(57) ABSTRACT

Molten resin supplied from a sprue to a runner in a mold closed state flows substantially radially in the runner and then flows from an entire circumferential edge portion of the runner into a cavity via a film gate. When the molten resin is filled in the cavity and molding is completed, the core part is slid while keeping the mold closed state to thereby cut a thin portion formed in the film gate in a manner of pulling the runner part by Z pins. After gate cutting, when the movable mold is opened with respect to the fixed mold, the resin molding (ring-shaped part) formed in the cavity is taken out.

### CROSS-REFERENCE TO RELATED APPLICATIONS

This application is based upon and claims the benefit of priority of the prior Japanese Patent Application No. 2008-165013, filed on Jun. 24, 2008, the entire contents of which are incorporated herein by reference.

### BACKGROUND OF THE INVENTION

1. Field of the Invention

The present invention relates to an injection mold preferable for forming a resin molding having a hole and a molding method for a resin molding using the same.

2. Description of the Related Art

Resin moldings having a hole are heavily used in various types of products. In an automobile for example, resin moldings are used in peripheries of fog lamps of a bumper, side bends of an instrument panel, a floor console, and the like.

When forming a resin molding having a hole, molten resin injected into a cavity of an injection mold flows to a periphery of the hole, and thereafter merges to fill the cavity. In general, what is called a weld line similar to a streak-like form is formed at this merging portion, and the weld line influences the surface appearance of the resin molding when left as it is.

Conventionally, as one of measures for the weld line formed in a molding of this type, there has been adopted an approach to paint the surface of a resin molding so as to obscure the weld line.

On the other hand, in recent years, there are resin moldings obtained using a resin material to which fine metal particles are added, and thus painting is unnecessary. In this case, since painting is not performed, it is required to suppress formation of the weld line itself.

As an invention made in consideration of the weld line, in Patent Document 1 for example, there is disclosed a molding method for a frame-shaped molding (specifically, a resin cabinet for a television receiving apparatus or the like). In the molding method disclosed in Patent Document 1, an upper mold and a lower mold are set in a state that a gap is provided with respect to a complete clamping state, and molten resin is filled in the gap for forming a molding through a columnar gate, a film-shaped gate, and a gap. After filling of the resin in the gap is completed, complete clamping is then performed to eliminate the gap, thereby carrying out gate cutting.

[Patent Document 1] Japanese Patent Application Laid-open No. H08-132481

However, the molding method disclosed in Patent Document 1 uses a structure having no runner (see paragraph [0009] and the like of Patent Document 1), in which the molten resin flows through the film-shaped gate from the columnar gate to the gap. This requires, accordingly, high fluidity of the molten resin, high mold temperature setting, and the like, thereby presenting problems of causing increase in cost and leading to lengthening of a molding cycle.

Moreover, since the method is arranged to carry out the gate cutting by clamping, it requires in the molding machine a press function as well as a special circuit, program, and the like for controlling the press function.

### SUMMARY OF THE INVENTION

The present invention is made in view of the above problems, and an object thereof is to suppress formation of a weld line while avoiding increase in cost and lengthening of a molding cycle.

An injection mold according to the present invention includes a sprue to be an inflow path for molten resin, a disk-shaped runner communicating at a center thereof with the sprue, a cavity arranged along an outer peripheral portion of the disk-shaped runner, and a film gate through which molten resin flows from an entire circumferential edge portion of the disk-shaped runner into the cavity.

Further, another characteristic of the injection mold according to the present invention is that a circumferential edge portion of the disk-shaped runner is thicker than a center portion thereof.

Further, another characteristic of the injection mold according to the present invention is that the injection mold further includes a fixed mold, a movable mold, and a core part provided to be relatively movable with respect to the movable mold, in which a Z pin holding a runner part formed in the disk-shaped runner is provided in the core part, and while the fixed mold and the movable mold are in a mold closed state, moving the core part causes the Z pin to move and thereby causes a thin portion formed in the film gate to be cut.

Further, in the injection mold according to the present invention, it is desirable that, when the disk-shaped runner has a diameter larger than 30 millimeters, the Z pin is arranged separately at a distance equal to or greater than 15 millimeters from the cavity. In this case, it is desirable that a plurality of Z pins identical to the Z pin are arranged symmetrically.

Further, another characteristic of the injection mold according to the present invention is that, when the disk-shaped runner has a diameter of 30 millimeters or smaller, the Z pin is arranged in a center of the disk-shaped runner.

Further, another characteristic of the injection mold according to the present invention is that the Z pin is replaceable with another pin.

A molding method for a resin molding according to the present invention includes molding a resin molding having a hole using an injection mold, in which the injection mold includes a sprue to be an inflow path for molten resin, a disk-shaped runner communicating at a center thereof with the sprue, a cavity arranged along an outer peripheral portion of the disk-shaped runner, and a film gate through which molten resin flows from an entire circumferential edge portion of the disk-shaped runner into the cavity.

### BRIEF DESCRIPTION OF THE DRAWINGS

FIG. 1A is a cross-sectional view showing a structure of an injection mold according to an embodiment;

FIG. 1B is a cross-sectional view showing the structure of the injection mold according to this embodiment;

FIG. 1C is a cross-sectional view showing the structure of the injection mold according to this embodiment;

FIG. 2 is an enlarged view of a main part of the injection mold according to this embodiment;

FIG. 3 is a view for explaining a Z pin;

FIG. 4 is a schematic view for explaining how resin flows;

FIG. 5 is a schematic view showing positions of Z pins;

FIGS. 6A and 6B are views for explaining a resin molding in this embodiment; and

FIG. 7 is a view for explaining an example of a resin molding to which the present invention can be applied.

### DETAILED DESCRIPTION OF THE PREFERRED EMBODIMENTS

Hereinafter, a preferred embodiment of the present invention will be explained with respect to the accompanying drawings.

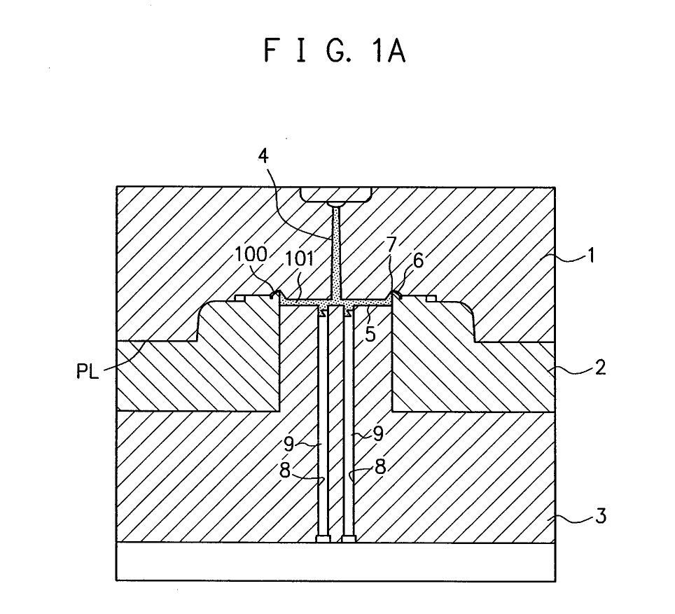

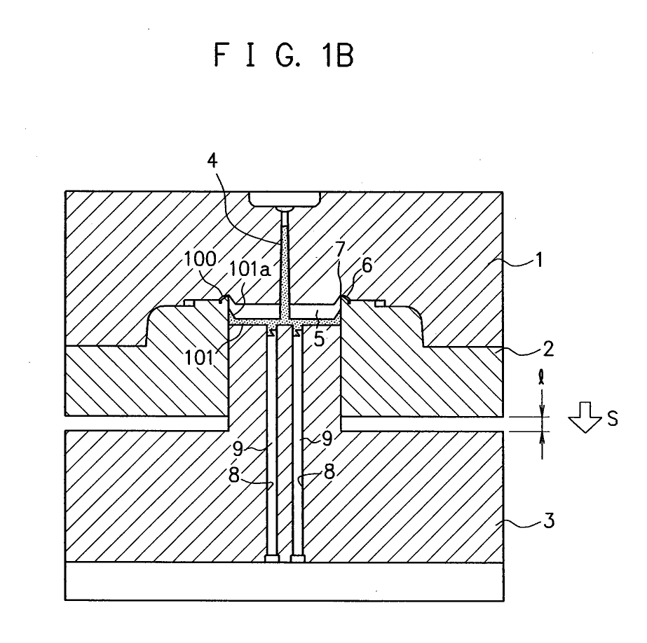

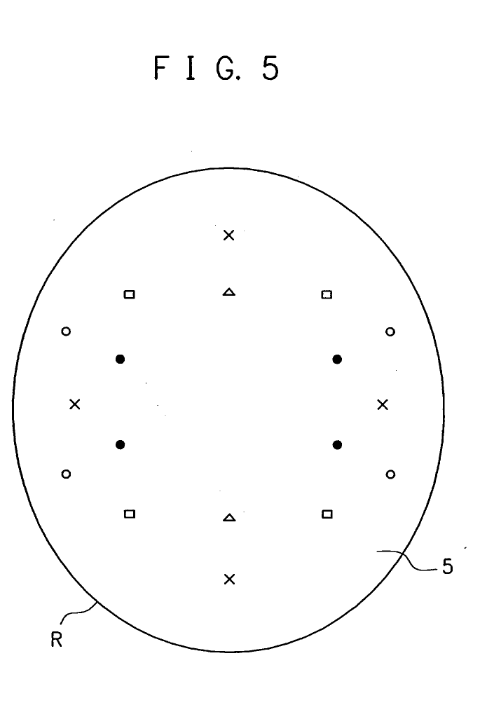

FIG. 1A to FIG. 1C are cross-sectional views showing a structure of an injection mold according to this embodiment. Further, FIG. 2 is an enlarged view of a main part of the injection mold according to this embodiment. In this embodiment, an example of forming a ring-shaped part 100 disposed around a shift lever of a passenger car as shown in FIGS. 6A and 6B will be explained.

The injection mold according to this embodiment includes a fixed mold 1 and a movable mold 2. Further, a core part 3 that is a separated body is provided so as to penetrate the movable mold 2, and the movable mold 2 and the core part 3 are relatively movable. Note that PL in FIG. 1 denotes a parting line.

A sprue 4 to be an inflow path for molten resin is formed in the fixed mold 1, to which molten resin is supplied from a not-shown nozzle.

Further, between the fixed mold 1 and the core part 3, a runner 5 having a disk shape in a mold closed state is formed. The sprue 4 communicates with a center part of the runner 5, and a concave 5a having a spherical surface is formed in a position facing the sprue 4 in a bottom face of the runner 5 (see FIG. 2) so that the molten resin supplied from the sprue 4 flows smoothly into the runner 5.

Further, between the fixed mold 1 and the movable mold 2, a cavity 6 having a ring shape in a mold closed state is formed. The cavity 6 is a space for molding the ring-shaped part 100 and is arranged slightly higher (on the fixed mold 1 side) than the runner 5 along an outer peripheral portion of the runner 5.

Further, between the fixed mold 1 and the movable mold 2, a film gate 7 through which molten resin flows from an entire circumferential edge portion of the runner 5 to the cavity 6 in a mold closed state is formed.

The runner 5 has a thickness of approximately 2 mm to 3 mm and the circumferential edge portion thereof has a shape such that the thickness increases upward (to the fixed mold 1 side) in a tapered form. On the other hand, the film gate 7 cuts off a thin portion formed therein as will be described later, and thus has a thickness of approximately 0.2 mm to be thin enough as compared to the runner 5.

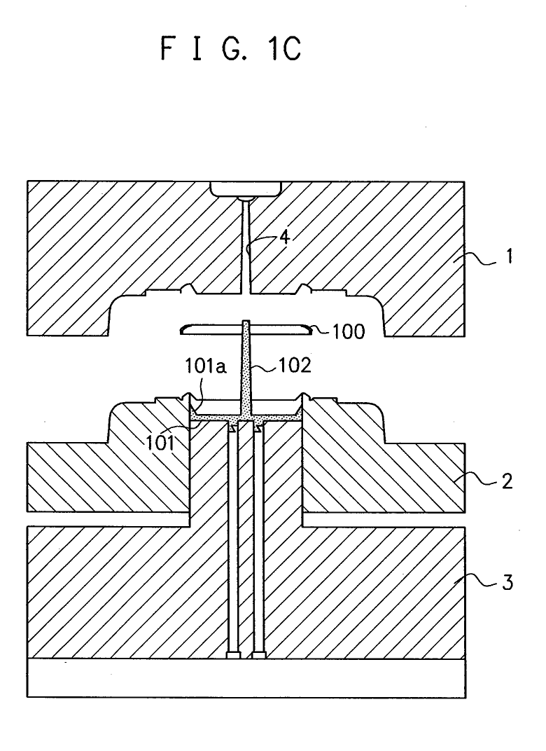

Further, in the core part 3, there are formed plural pin accommodating portions 8 opening in the bottom face of the runner 5, and Z pins 9 are accommodated in the respective pin accommodating portions 8. As shown in FIG. 3, the Z pins 9 each have a tip in a Z shape when seen laterally, and part of the molten resin flowing in the runner 5 flows into spaces 10 formed by the pin accommodating portions 8 and the Z pins 9. When the molten resin hardens in this state, a runner part 101 formed in the runner 5 is held by the Z pins 9.

Next, with reference to FIG. 1A to FIG. 1C, a molding method using the injection mold according to this embodiment will be explained. Here, a resin material to which fine metal particles (for example, particles of aluminum having a diameter of 5 μm to 20 μm) are added is used to form the ring-shaped part 100, which is a non-painted product.

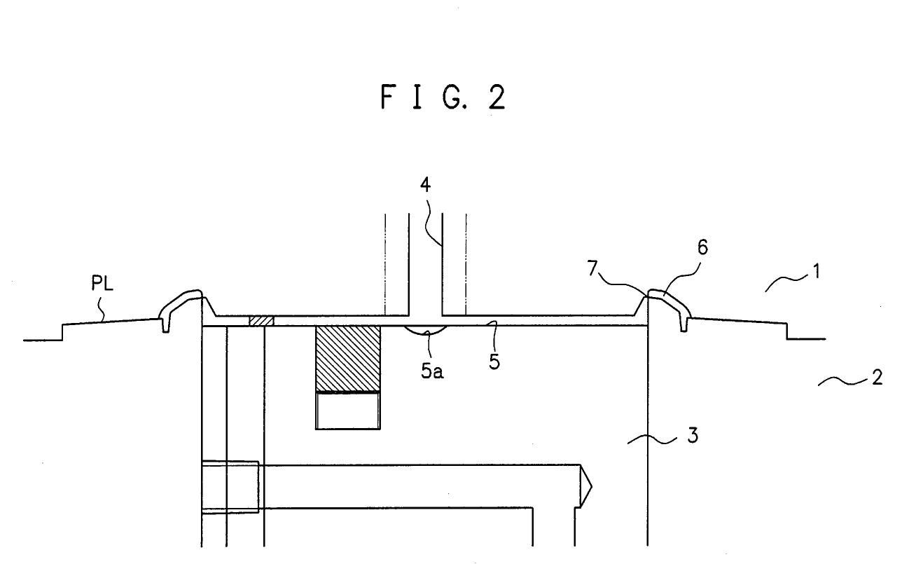

As shown in FIG. 1A, in a mold closed state, molten resin is supplied from the not-shown injection nozzle to the sprue 4. The molten resin supplied from the sprue 4 to the runner 5 flows substantially radially in the runner 5 and then flows from the entire circumferential edge portion of the runner 5 into the cavity 6 via the film gate 7, as shown by arrows in FIG. 4. Since the molten resin thus flows substantially radially and evenly from the center part to the cavity 6, no weld line is formed in the resin molding 100.

When the molten resin is filled in the cavity 6 and molding is completed, as shown in FIG. 1B the core part 3 is slid by a predetermined stroke 1 (see arrow S in FIG. 1B) while keeping the mold closed state by a PL lock. When the core part 3 is slid, the Z pins 9 move along with the slide. Here, as described above, since the runner part 101 formed in the runner 5 is held by the Z pins 9, movement of the Z pins 9 causes the runner part 101 to move in a manner of being pulled by the Z pins. On the other hand, the resin molding 100 formed in the cavity 6 is still fixed with the fixed mold 1 and the movable mold 2. Therefore, movement of the core part 3 results in cutting of the thin portion formed in the film gate 7 (gate cutting).

At the time of gate cutting, the resin molding 100 formed in the cavity 6 is fixed firmly by the fixed mold 1 and the movable mold 2, and thus the resin molding 100 will not be deformed by external force when the thin portion is cut. Further, the runner part 101 formed in the runner 5 has high rigidity and is not easily deformed because it is thick enough (with a thickness of approximately 2 mm to 3 mm) as compared to the thin portion (with a thickness of approximately 0.2 mm) and further has a taper part 101a on its circumferential edge portion. Thus, the gate cutting can be performed securely.

After the gate cutting, when the movable mold 2 is opened with respect to the fixed mold 1 as shown in FIG. 1C, the resin molding (ring-shaped part) 100 formed in the cavity 6 is taken out.

After the resin molding 100 is formed as above, a columnar part 102 formed in the sprue 4 and the runner part 101 formed in the runner 5 can be pulverized and reused. In this case, when a normal nozzle is used as the injection nozzle, the pulverized material does not have regular grain shapes like pellets, and thus small portions therein do not melt sufficiently when being injected. This causes uneven mixing and generates a radial flow mark along the flow of resin in the resin molding. However, when a mixing nozzle is used, such a problem does not occur and the resin molding does not have any appearance problem, and thus the pulverized material can be reused. It has been found that, even when 100% of the pulverized material is reused, ΔE (color difference) becomes stable to be 3 or lower for about three times, and the resin molding does not have any appearance problem. Further, it is desirable to use the mixing nozzle when the pulverized material is used, but the normal nozzle may be used when a virgin material is used.

Hereinafter, an arrangement relationship of the Z pins 9 will be explained. In view of holding the runner part 101 for gate cutting, it is conceivable that the Z pins 9 are preferred to be arranged close to the film gate 7.

On the other hand, part of the molten resin flowing in the runner 5 flows into the spaces 10 formed by the pin accommodating portions 8 and the Z pins 9, and therefore some disturbance occurs in the flow of molten resin at the positions of the spaces. Accordingly, when the Z pins 9 are close to the cavity 6, the flow of molten resin becomes uneven just before entering the cavity 6, which may adversely influence the appearance of the resin molding 100.

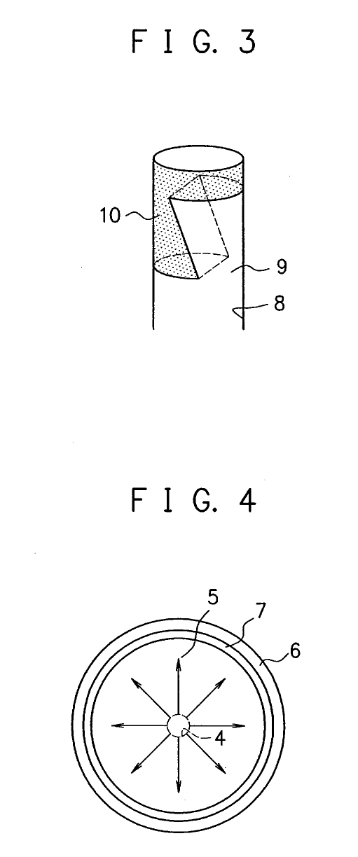

The present inventor modified the mold so that positions of the plural Z pins 9 are changeable to 10 mm, 15 mm, 20 mm, 25 mm, and 30 mm from the inside of the cavity 6 when the diameter of the disk-shaped runner 5 is larger than 30 mm, and conducted an experiment to investigate the influence of positions of the Z pins 9 on the appearance of the resin molding 100. FIG. 5 is a schematic view showing positions (10 mm (◯), 15 mm (x), 20 mm (□), 25 mm () 30 mm (Δ)) of the Z pins 9 in the disk-shaped runner 5 having an elliptic shape. Note that a line R in FIG. 5 shows the inside of the cavity 6.

With the other conditions being the same, results of visually checking appearances of resin moldings 100 molded with positions of the Z pins 9 being changed are shown in Table 1. From the results in Table 1, it was found that it is desirable to arrange the Z pins 9 separately at a distance equal to or greater than 15 mm from the inside of the cavity 6.

TABLE 1

| | PIN POSITIONS | | | | |
|---|---|---|---|---|---|
| | 10 mm | 15 mm | 20 mm | 25 mm | 30 mm |
| RESULTS | NG | OK | OK | OK | OK |

In addition, it is preferable that the plural Z pins 9 are arranged symmetrically with respect to the center of the runner 5. Further, the number of Z pins 9 may be changed appropriately depending on the size of and/or the resin material for the runner 5.

When the diameter of the disk-shaped runner 5 is 30 mm or smaller, one Z pin 9 may be arranged in a center of the runner 5.

As described above, due to the structure that the molten resin flows in the runner 5 from the sprue 4 to the cavity 6, fluidity of the molten resin will not be disturbed, and thus increase in cost and lengthening of a molding cycle can be avoided.

Moreover, although it is necessary to control the core part 3 to slide before the movable mold 2 moves, basically the gate cutting can be performed only by an operation in the opening direction with a hydraulic device or the like. Thus, a press function and a special circuit, program, and the like for controlling the press function as in conventional techniques are not necessary.

In the foregoing, the present invention has been explained together with various embodiments, but the present invention is not limited to these embodiments. Modifications and the like may be made without departing from the spirit of the present invention. For example, the hole of the ring-shaped part 100 may either be a perfect circular shape or an elliptic shape.

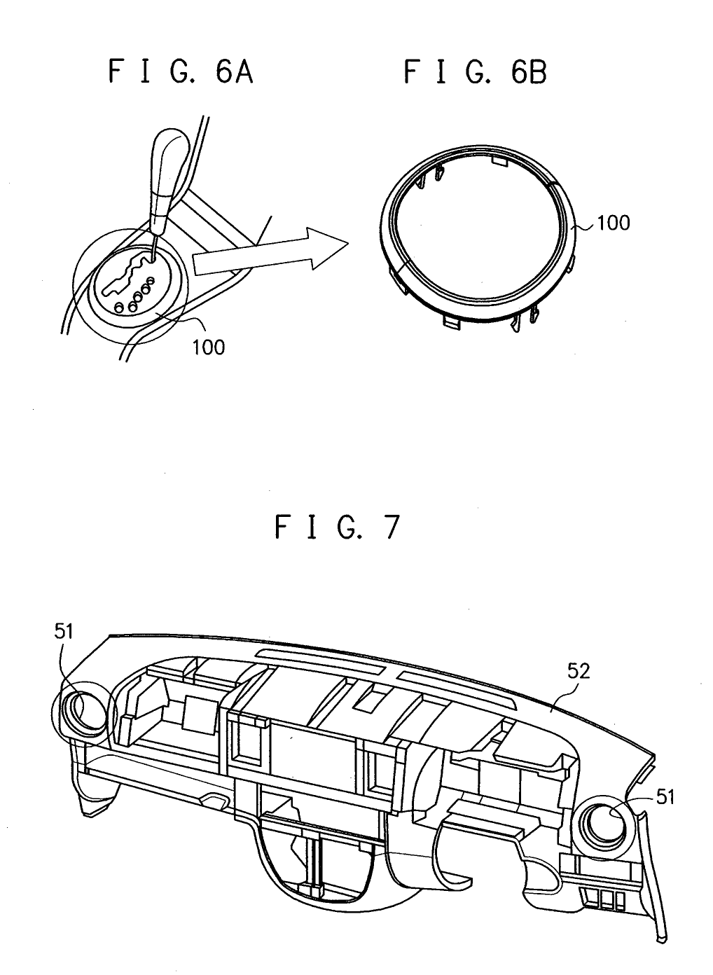

Further, although the ring-shaped part 100 has been explained in the above embodiments, the present invention may be applied for forming general resin moldings having a hole (parts which may present a problem of weld line on the outer periphery of a hole). For example, as shown in FIG. 7, the present invention may be applied to molding of a bumper 52 having holes 51 for attaching fog lamps. In this case, when the fog lamps are optional parts and it is possible to select whether to attach the fog lamps, the runner part 101 can be left by replacing the Z pins 9 with flat pins, that is, the holes 51 can be left closed. Thus, selection of moldings can be performed easily by the same mold.

According to the present invention, formation of a weld line is suppressed while increase in cost and lengthening of a molding cycle is avoided.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An injection mold, comprising:
a sprue to be an inflow path for molten resin;
a disk-shaped runner communicating at a center thereof with the sprue;
a cavity arranged along an outer peripheral portion of the disk-shaped runner; and
a film gate through which molten resin flows from an entire circumferential edge portion of the disk-shaped runner into the cavity.

2. The injection mold according to claim 1, wherein
a circumferential edge portion of the disk-shaped runner is thicker than a center portion thereof.

3. The injection mold according to claim 1, further comprising:
a fixed mold;
a movable mold; and
a core part provided to be relatively movable with respect to the movable mold,
wherein a Z pin holding a runner part formed in the disk-shaped runner is provided in the core part, and
wherein while the fixed mold and the movable mold are in a mold closed state, moving the core part causes the Z pin to move and thereby causes a thin portion formed in the film gate to be cut.

4. The injection mold according to claim 2, further comprising:
a fixed mold;
a movable mold; and
a core part provided to be relatively movable with respect to the movable mold,
wherein a Z pin holding a runner part formed in the disk-shaped runner is provided in the core part, and
wherein while the fixed mold and the movable mold are in a mold closed state, moving the core part causes the Z pin to move and thereby causes a thin portion formed in the film gate to be cut.

5. The injection mold according to claim 3, wherein
when the disk-shaped runner has a diameter larger than 30 millimeters, the Z pin is arranged separately at a distance equal to or greater than 15 millimeters from the cavity.

6. The injection mold according to claim 4, wherein
when the disk-shaped runner has a diameter larger than 30 millimeters, the Z pin is arranged separately at a distance equal to or greater than 15 millimeters from the cavity.

7. The injection mold according to claim 5, wherein
a plurality of Z pins identical to the Z pin are arranged symmetrically.

8. The injection mold according to claim 6, wherein
a plurality of Z pins identical to the Z pin are arranged symmetrically.

9. The injection mold according to claim 3, wherein
when the disk-shaped runner has a diameter of 30 millimeters or smaller, the Z pin is arranged in a center of the disk-shaped runner.

10. The injection mold according to claim 4, wherein
when the disk-shaped runner has a diameter of 30 millimeters or smaller, the Z pin is arranged in a center of the disk-shaped runner.

11. The injection mold according to claim 3, wherein
the Z pin is replaceable with another pin.

12. A molding method for a resin molding, the method comprising
molding a resin molding having a hole using an injection mold, wherein the injection mold comprises:
a sprue to be an inflow path for molten resin;
a disk-shaped runner communicating at a center thereof with the sprue;
a cavity arranged along an outer peripheral portion of the disk-shaped runner; and
a film gate through which molten resin flows from an entire circumferential edge portion of the disk-shaped runner into the cavity.
